(19) United States
(12) Patent Application Publication
(10) Pub. No.: US 2012/0145953 A1
(43) Pub. Date: Jun. 14, 2012

(54) LITHIUM PRECURSORS FOR LixMyOz MATERIALS FOR BATTERIES

(76) Inventors: Venkateswara R. Pallem, Hockessin, DE (US); Christian Dussarrat, Wilmington, DE (US)

(21) Appl. No.: 13/378,093

(22) PCT Filed: Jun. 30, 2010
(86) PCT No.: PCT/US2010/040655

§ 371 Date: Mar. 5, 2012

Related U.S. Application Data
(60) Provisional application No. 61/222,336, filed on Jul. 1, 2009.

(51) Int. Cl. H01M 4/485; H01M 4/525; H01M 4/505; C01D 15/02

(52) U.S. Cl. 252/182.1; 423/594.4; 423/594.6; 423/594.8; 423/599

(57) ABSTRACT

Disclosed are lithium-containing compounds and methods of utilizing the same. The disclosed compounds may be used to deposit alkali metal-containing layers using vapor deposition methods such as chemical vapor deposition or atomic layer deposition. In certain embodiments, the lithium-containing compounds include a ligand and at least one aliphatic group as substituents selected to have greater degrees of freedom than the usual substituent.

### BACKGROUND

Atomic layer deposition (ALD) processes provide one method to deposit highly conformal thin films by exposing the surface of the substrate to alternating vapors of two or more chemical reactants. The vapor from a first organometallic precursor is brought to the surface of the substrate onto which the desired film is to be deposited. Any unreacted precursor and by-products are purged from the system by using a vacuum, an inert gas purge, or both. In the next step, the vapor from a second precursor is brought to the surface of the substrate and allowed to react with the first precursor, with any excess unreacted second precursor and byproduct vapor being similarly removed. Each step in the ALD process typically deposits a monolayer of the desired film. By repeating this sequence of steps, the desired film thickness may be obtained.

Organometallic compounds suitable to be used as vapor deposition precursors should possess sufficient volatility and thermal stability. Also, these precursors must have sufficient reactivity toward the substrate surface and the other chemical reactants used to deposit desired films. The need for developing new vapor deposition processes for alkali materials is clear. Unfortunately the successful integration of compounds used for vapor deposition processes has proven to be difficult. Widely know metal halides type compounds have very high melting points and very low volatilities. For example, LiF has a melting point of 842° C., LiCl has a melting point of 614° C., and LiBr has a melting point of 550° C. Additionally, films formed from these compounds are known to incorporate halide impurities.

Non-halide sources of alkali compounds are also well known. For example, metal alkyl compounds are available (alkyl lithium in solution), such as such as Li(Me), Li(Et), Li(nBu), and Li(tBu). Also available are metal amides, such as LiN(Me)₂ and Li(N(Et)₂, and metal silylamides, such as LiN(SiMe₃)₂. However, all of these compounds are very reactive to moisture and pyrophoric. Additionally, the metal silylamides contain silicon, which may be deposited as a detrimental impurity in the thin film.

Therefore, the need for developing new vapor deposition processes for alkali materials remains.

### SUMMARY

Disclosed are methods of forming a lithium-containing film by vapor deposition. A reaction chamber having at least one substrate disposed therein is provided. A vapor containing a lithium-containing precursor is introduced into the reaction chamber. The vapor is contacted with the substrate to form a lithium-containing layer on at least one surface of the substrate using a vapor deposition process. The disclosed methods may include one or more of the following aspects:
the lithium-containing precursor being selected from the group consisting of:

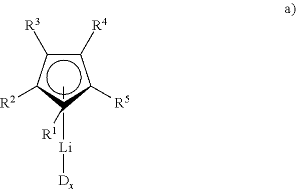

wherein:
each R¹, R², R³, R⁴, and R⁵ is independently selected from:
   i. hydrogen;
   ii. linear or branched C₁-C₁₅ alkyl, alkenyl, alkynyl, or alkylsilyl groups, which are independently substituted or unsubstituted; or
   iii. cyclic, bicyclic, or tricyclic ring systems, which are independently substituted or unsubstituted;
each D is independently selected from a monodentate, bidentate, tridentate, or polydentate neutral coordinating ligand system; and
x≧0;

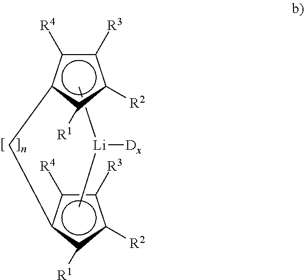

wherein:
each R¹, R², R³, and R⁴ is independently selected from:
   i. hydrogen;
   ii. linear or branched C₁-C₁₅ alkyl, alkenyl, alkynyl, or alkylsilyl groups, which are independently substituted or unsubstituted; or
   iii. cyclic or bicyclic ring systems, which are independently substituted or unsubstituted;
n=0-4;
each D is independently selected from a monodentate, bidentate, tridentate, or polydentate neutral coordinating ligand system; and
x≧0;

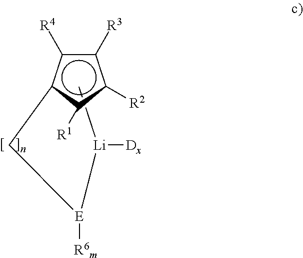

wherein:
each R¹, R², R³, R⁴ and R⁶ is independently selected from:
   i. hydrogen;
   ii. linear or branched C₁-C₁₅ alkyl, alkenyl, alkynyl, or alkylsilyl groups, which are independently substituted or unsubstituted; or
   iii. cyclic or bicyclic ring systems, which are independently substituted or unsubstituted;
E=N, O, S, P;
each D is independently selected from a monodentate, bidentate, tridentate, or polydentate neutral coordinating ligand system; and
n=0-4, m≧0 and x≧0;

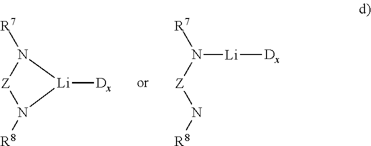

wherein:
each R⁷ and R⁸ is independently selected from:
   i. hydrogen; or
   ii. linear or branched C₁-C₁₅ alkyl, alkenyl, alkynyl, or alkylsilyl groups, which are independently substituted or unsubstituted;
Z is any linear or branched C₁-C₁₅ alkyl, alkenyl, or alkynyl groups, which are independently substituted or unsubstituted and Z bridges two nitrogen centers at any point of the alkyl, alkenyl, or alkynyl groups;
D is independently selected from a monodentate, bidentate, tridentate, or polydentate neutral coordinating ligand system; and
x≧0; and

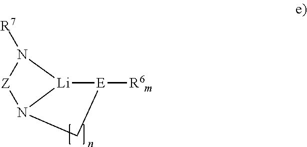

wherein:
each R⁶ and R⁷ is independently selected from:
   i. hydrogen;
   ii. linear or branched C₁-C₁₅ alkyl, alkenyl, alkynyl, or alkylsilyl groups, which are independently substituted or unsubstituted;
E=N, O, S, P; and
n=0-4 and m≧0;
each D being independently selected from the group consisting of THF, pyridine, pyrrole, imidazole, DME, 1,2 diethoxyethane, bipyridine, diene, triene, tmeda, and pmdeta;
each D being independently selected from the group consisting of THF, DME, and tmeda;
the lithium-containing precursor being selected from group consisting of Li(Me₅Cp).THF, Li(Me₄Cp).THF, Li(Me₄EtCp).THF, Li(iPr₃Cp).THF, Li(tBu₃Cp).THF, Li(tBu₂Cp).THF, Li(Me₅Cp), Li(Me₄Cp), Li(Me₄EtCp), Li(iPr₃Cp), Li(tBu₃Cp), Li(tBu₂Cp), Li(Me₃SiCp).THF, Li(Et₃SiCp).THF, Li(Me₃SiCp), and Li(Et₃SiCp);
the lithium-containing precursor being selected from group consisting of Li(Me₅Cp).THF, Li(iPr₃Cp).THF, Li(tBu₃Cp).THF, and Li(tBu₂Cp);
the lithium-containing precursors being selected from group consisting of Li(N^{Me}-amd).THF, Li(N^{Me}-fmd).THF, (N^{Et}-amd).THF, Li(N^{Et}-fmd).THF, Li(N^{iPr}-amd).THF, Li(N^{iPr}-fmd).THF, Li(N^{tBu}-amd).THF, Li(N^{tBu-fmd).THF, Li(N}^{Me}-amd), Li(N^{Me}-fmd), (N^{Et}-amd), Li(N^{Et}-fmd), Li(N^{iPr}-amd), Li(N^{iPr}-fmd), Li(N^{tBu}-amd), and Li(N^{tBu}-fmd);
introducing a first reactant species into the reaction chamber;
introducing into the reaction chamber a second metal-containing precursor and a second reactant species and depositing a film comprising a lithium metal oxide on the substrate;
the second metal precursor containing a metal selected from the group consisting of nickel, cobalt, iron, vanadium, manganese and phosphorus;
the first and second reactant species being independently selected form the group consisting of O₃, O₂, H₂O, H₂O₂, carboxylic acids (C₁-C₁₀, linear and branched), formaline, formic acid, alcohols, and mixtures thereof;
the lithium metal oxide having the following formula: LiₓM_{y}O_{z}, wherein M=Ni, Co, Fe, V, Mn, or P and x, y, and z range from 1 to 8 inclusive;
the lithium metal oxide being selected from the group consisting of Li₂NiO₂, Li₂CoO₂, Li₂V₃O₈, LiₓV₂O₅, and Li₂Mn₂O₄; and
the vapor deposition process being atomic layer deposition.

### Notation and Nomenclature

Certain abbreviations, symbols, and terms are used throughout the following description and claims and include: the abbreviation “ALD” refers to atomic layer deposition; the abbreviation “CVD” refers to chemical vapor deposition; the abbreviation “LPCVD” refers to low pressure chemical vapor deposition; the abbreviation “P-CVD” refers to pulsed chemical vapor deposition; the abbreviation “PE-ALD” refers to plasma enhanced atomic layer deposition; the abbreviation “R₁-NC(R₃)N-R₂” refers to the following chemical structure:

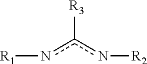

the abbreviation “N^{Z}-amd” refers to Z-NC(CH₃)N-Z , which is R₁-NC(R₃)N-R₂ wherein R₃ is CH₃ and R₁ and R₂ are both Z, which is a defined alkyl group such as Me, Et, Pr, iPr, or tBu; the abbreviation “N^{z}-fmd” refers to Z-NC(H)N-Z, which is R₁-NC(R₃)N-R₂ wherein R₃ is H and R₁ and R₂ are both Z, which is a defined alkyl group such as Me, Et, Pr, iPr, or tBu; the abbreviation “Me” refers to a methyl group; the abbreviation “Et” refers to an ethyl group; the abbreviation “Pr” refers to a propyl group; the abbreviation “iPr” refers to an isopropyl group; the abbreviation “tBu” refers to a tertiary butyl group; the abbreviation “Cp” refers to cyclopentadiene; the term “aliphatic” refers to a C1-C6 linear or branched chain alkyl group; the term “alkyl group” refers to saturated functional groups containing carbon and hydrogen atoms; the term “alkenyl group” refers to unsaturated functional groups containing carbon and hydrogen atoms, with at least one double bond between two of the carbon atoms; the term “alkylnyl group” refers to unsaturated functional group containing carbon and hydrogen atoms, with at least one triple bond between two of the carbon atoms; the abbreviation “MIM” refers to Metal Insulator Metal (a structure used in capacitors); the abbreviation “DRAM” refers to dynamic random access memory; the abbreviation “FeRAM” refers to ferroelectric random access memory; the abbreviation “THF” refers to tetrahydrofuran; the abbreviation “DME” refers to dimethoxyethane; the abbreviation “tmeda” refers to tetramethylethylenediamine; the abbreviation “pmdeta” refers to pentamethyldiethylenetetraamine; the abbreviation “TGA” refers to thermogravimetric analysis; and the abbreviation “TMA ” refers to trimethyl aluminum.

### BRIEF DESCRIPTION OF THE FIGURES

For a further understanding of the nature and objects of the present invention, reference should be made to the following detailed description, taken in conjunction with the accompanying drawings, wherein:

FIG. 1 is a flow diagram of one embodiment of the disclosed lithium film deposition method;

FIG. 2 is a graph of thermogravimetric analysis (TGA) data demonstrating percent of weight loss vs. temperature of Li(N^{iPr}-amd);

FIG. 3 is a graph of TGA data of Li(N^{tBu}-amd); and

FIG. 4 is a graph of TGA data of Li(tBu₃Cp)·Et₂O.

### DETAILED DESCRIPTION OF THE PREFERRED EMBODIMENT

Disclosed herein are non-limiting embodiments of methods, apparatus, and compounds which may be used in the manufacture of semiconductor, photovoltaic, LCD-TFT or flat panel type devices. Disclosed are organometallic compounds (precursors) and their application in processes for depositing metal-containing thin films. In some embodiments, the disclosed organometallic compounds are useful for manufacturing metal-containing thin films by chemical vapor deposition or atomic layer deposition. The disclosed volatile lithium-containing precursors are derived from cyclopentadienyl and/or nitrogen-rich chelating compounds.

The lithium-containing precursor may have at least one cyclopentadienyl ligand and an optional neutral coordinating ligand, for example, a bidentate or tridentate, derived from acyclic or cyclic systems. In some embodiments, the lithium-containing precursor is depicted by Formula I, (R¹R²R³R⁴R⁵Cp)LiDₓ, as follows:

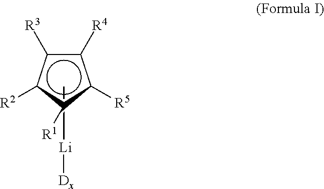

wherein:
each R¹, R², R³, R⁴, and R⁵ is independently selected from:
   i. hydrogen;
   ii. linear or branched C₁-C₁₅ alkyl, alkenyl, alkynyl, or alkylsilyl groups which are independently substituted or unsubstituted; or
   iii. cyclic, bicyclic, or tricyclic ring systems, which are independently substituted or unsubstituted (in the bicyclic ring system R₂ and R₃ or R₄ and R₅ form a 5- to 7-membered ring system and in the tricyclic ring system R₂ and R₃ and R₄ and R₅ form a 5- to 7-membered ring system);
each D is independently selected from a monodentate, bidentate, tridentate, and polydentate neutral coordinating ligand system, which is selected from acyclic or cyclic ligand systems, such as, THF, pyridine, pyrrole, imidazole, DME, 1,2 diethoxyethane, bipyridine, diene, triene, tmeda, and pmdeta; and
x≧0.

Examples of the lithium-containing precursors of Formula I include Li(Me₅Cp).THF, Li(Me₄Cp).THF, Li(Me₄EtCp).THF, Li(iPr₃Cp).THF, Li(tBu₃Cp).THF, Li(tBu₂Cp).THF, Li(Me₅Cp), Li(Me₄Cp), Li(Me₄EtCp), Li(iPr₃Cp), Li(tBu₃Cp), Li(tBu₂Cp), Li(Me₃SiCp).THF, Li(Et₃SiCp).THF, Li(Me₃SiCp), and Li(Et₃SiCp). Preferably, the lithium-containing precursor of Formula I is selected from Li(Me₅Cp).THF, Li(iPr₃Cp).THF, Li(tBu₃Cp).THF, or Li(tBu₂Cp).

Alternatively, the lithium-containing precursor may have at least one bridged cyclopentadienyl ligand (ansa-type). In some embodiments, the lithium-containing precursor is depicted by Formula II, [(R¹R²R³R⁴Cp)₂-(CH₂)ₙ]-LiDₓ, as follows:

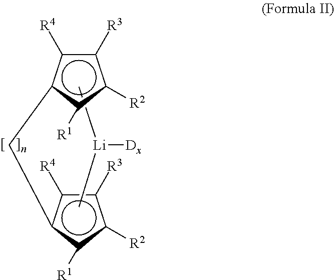

wherein:
each R¹, R², R³, and R⁴ is independently selected from:
   i. hydrogen;
   ii. linear or branched C₁-C₁₅ alkyl, alkenyl, alkynyl, or alkylsilyl groups, which are independently substituted or unsubstituted; iii. cyclic or bicyclic ring systems, which are independently substituted or unsubstituted (in the bicyclic ring system R₂ and R₃ form a 5- to 7-membered ring system); and
   iv. n=0-4;
each D is independently selected from a monodentate, bidentate, tridentate, and polydentate neutral coordinating ligand system, which may be selected from acyclic or cyclic ligand systems, such as, THF, pyridine, pyrrole, imidazole, DME, 1,2 diethoxyethane, bipyridine, diene, triene, tmeda, and pmdeta; and
x≧0.

In another alternative, the lithium-containing precursor may have at least one cyclopentadienyl ligand with a neutral coordinating pendent arm. In some embodiments, the lithium-containing precursor is depicted by Formula III, [(R¹R²R³R⁴Cp)-(CH₂)ₙ-E(R⁶ₘ)]LiDₓ, as follows:

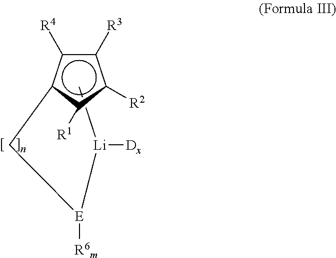

wherein:
each R¹, R², R³, R⁴ and R⁶ is independently selected from:
   i. hydrogen;
   ii. linear or branched C₁-C₁₅ alkyl, alkenyl, alkynyl, or alkylsilyl groups, which are independently substituted or unsubstituted; and
   iii. cyclic or bicyclic ring systems, which are independently substituted or unsubstituted (in the bicyclic ring system, R₂ and R₃ form a 5- to 7-membered ring system);
E=N, O, S, or P;
each D is independently selected from a monodentate, bidentate, tridentate, and polydentate neutral coordinating ligand system, which is selected from acyclic or cyclic ligand systems, such as THF, pyridine, pyrrole, imidazole, DME, 1,2 diethoxyethane, bipyridine, diene, triene, tmeda, or pmdeta; and
n=0-4, and x≧0.

In another alternative, the lithium-containing precursor may have at least one chelating ligand and at least one optional neutral coordinating ligand, for example, a bidentate or tridentate, derived from acyclic or cyclic systems. In some embodiments, the lithium-containing precursor is depicted by Formula IV or V, (R⁷-N-Z-N-R⁸)LiDₓ, as follows:

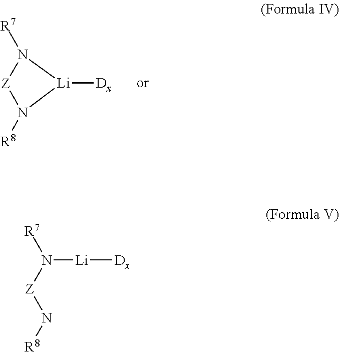

wherein:
each R⁷ and R⁸ is independently selected from:
   i. hydrogen;
   ii. linear or branched C₁-C₁₅ alkyl, alkenyl, alkynyl, or alkylsilyl groups, which are independently substituted or unsubstituted;
Z is any linear and branched C₁-C₁₅ alkyl, alkenyl and alkynyl groups, which are independently substituted or unsubstituted and Z bridges two nitrogen centers at any point of alkyl, alkenyl and alkynyl groups;
each D is independently selected from a monodentate, bidentate, tridentate, and polydentate neutral coordinating ligand system, which is selected from acyclic or cyclic ligand systems, such as THF, pyridine, pyrrole, imidazole, DME, 1,2 diethoxyethane, bipyridine, diene, triene, tmeda, and pmdeta; and
x≧0.

Examples of the lithium-containing precursors of Formula IV include Li(N^{Me}-amd).THF, Li(N^{Me}-fmd).THF, (N^{Et}-amd).THF, Li(N^{Et}-fmd).THF, Li(N^{iPr}-amd).THF, Li(N^{iPr}-fmd).THF, Li(N^{tBu}-amd).THF, Li(N^{tBu}-fmd).THF, Li(N^{Me}-amd), Li(N^{Me}-fmd), Li(N^{Et}-amd), Li(N^{Et}-fmd), Li(N^{iPr}-amd), Li(N^{iPr}-fmd), Li(N^{tBu}-amd), and Li(N^{tBu-fmd).}

In the last alternative, the lithium-containing precursor may have at least one chelating ligand with neutral coordinating pendent arm. In some embodiments, the lithium-containing precursor is depicted by Formula VI, (R⁷-N-Z-N-(CH₂)ₙ-E(R⁶ₘ)Li, as follows:

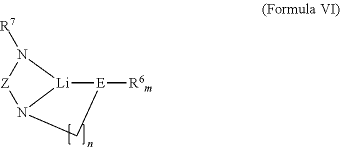

wherein:
each R⁶ and R⁷ is independently selected from:
   i. hydrogen;
   ii. linear or branched C₁-C₁₅ alkyl, alkenyl, alkynyl, or alkylsilyl groups, which are independently substituted or unsubstituted;
E=N, O, S, P; and
n=0-4 and m≧0.

The disclosed lithium-containing precursors are synthesized by methods known in the art. The disclosed lithium-containing precursors are low melting point solids or liquids at room temperature. The disclosed lithium-containing precursors exhibit increased volatility, thermal stability, decreased moisture reactivity, and are less pyrophoric than previous lithium-containing precursors. Finally the disclosed lithium-containing precursors do not contain a reactive silicon, which may contaminate the resulting lithium-containing layer. Although silyl substituents may be present as a pendant group on the ligands of the lithium-containing precursor, it is not expected that the silicon atom will detach from the pendant group to contaminate the resulting lithium-containing layer because the silicon atom is not bound to the lithium atom. The disclosed lithium-containing precursors may be used to deposit various lithium heterometal-containing films by ALD or CVD.

The disclosed methods provide for forming a lithium-containing layer on a substrate (e.g., a semiconductor substrate or substrate assembly) using the disclosed lithium-containing precursors in a vapor deposition process. The method may be useful in the manufacture of semiconductor structures, such as batteries. The method includes: providing a substrate; providing a vapor including at least one lithium-containing precursor selected from formula 1-VI and contacting the vapor with the substrate (and typically directing the vapor to the substrate) to form a lithium-containing layer on at least one surface of the substrate. An oxygen source, such as O₃, O₂, H₂O, NO, H₂O₂, carboxylic acids (C₁-C₁₀ linear and branched), acetic acid, formalin, formic acid, alcohols, para-formaldehyde, and combinations thereof; preferably O₃, O₂, H₂O, NO, and combinations thereof; and more preferably H₂O, may also be provided.

The disclosed lithium-containing precursor compounds may be deposited to form lithium-containing films using any deposition methods known to those of skill in the art. Examples of suitable deposition methods include without limitation, a thermal, plasma, or remote plasma process in atomic layer deposition (ALD), plasma enhanced atomic layer deposition (PE-ALD), chemical vapor deposition (CVD), pulsed chemical vapor deposition (P-CVD), low pressure chemical vapor deposition (LPCVD), or combinations thereof. Preferably, the deposition method is ALD or PE-ALD.

The type of substrate upon which the lithium-containing film will be deposited will vary depending on the final use intended. In some embodiments, the substrate may be chosen from oxides which are used as dielectric materials in MIM, DRAM, or FeRam technologies (for example, HfO₂ based materials, TiO₂ based materials, ZrO₂ based materials, rare earth oxide based materials, ternary oxide based materials, etc.) or from nitride-based films (for example, TaN) that are used as an oxygen barrier between copper and the low-k layer. Other substrates may be used in the manufacture of semiconductors, photovoltaics, LCD-TFT, or flat panel devices. Examples of such substrates include, but are not limited to, solid substrates such as metal nitride containing substrates (for example, TaN, TiN, WN, TaCN, TiCN, TaSiN, and TiSiN); insulators (for example, SiO₂, Si₃N₄, SiON, HfO₂, Ta₂O₅, ZrO₂, TiO₂, Al₂O₃, and barium strontium titanate); or other substrates that include any number of combinations of these materials. The actual substrate utilized may also depend upon the specific precursor embodiment utilized. In many instances though, the preferred substrate utilized will be selected from TiN, SRO, Ru, and Si type substrates.

The lithium-containing precursor is introduced into a reaction chamber containing at least one substrate. The reaction chamber may be any enclosure or chamber of a device in which deposition methods take place, such as, without limitation, a parallel-plate type reactor, a cold-wail type reactor, a hot-wall type reactor, a single-wafer reactor, a multi-wafer reactor, or other such types of deposition systems.

The reaction chamber may be maintained at a pressure ranging from about 0.5 mTorr to about 20 Torr. In addition, the temperature within the reaction chamber may range from about 250° C. to about 600° C. One of ordinary skill in the art will recognize that the temperature may be optimized through mere experimentation to achieve the desired result.

The substrate may be heated to a sufficient temperature to obtain the desired lithium-containing film at a sufficient growth rate and with desired physical state and composition. A non-limiting exemplary temperature range to which the substrate may be heated includes from 150° C. to 600° C. Preferably, the temperature of the substrate remains less than or equal to 450° C.

The lithium-containing precursor may be supplied in neat form, for example as a liquid or low melting solid, or in a blend form with a suitable solvent. Exemplary solvents include, without limitation, aliphatic hydrocarbons, aromatic hydrocarbons, heterocyclic hydrocarbons, ethers, glymes, glycols, amines, polyamines, cyclicamines, alkylated amines, alkylated polyamines and mixtures thereof. Preferable solvents include ethyl benzene, diglyme, triglyme, tetraglyme, pyridine, xylenes, mesitylene, decane, dodecane, and mixtures thereof. The concentration of the lithium-containing precursor is typically in the range of approximately 0.02 to approximately 2.0 M, and preferably approximately 0.05 to approximately 0.2M.

The neat or blended lithium-containing precursor may be fed in liquid state to a vaporizer where it is vaporized before it is introduced into the reaction chamber. Alternatively, the neat or blended lithium-containing precursor may be vaporized by passing a carrier gas into a container containing the lithium-containing precursor or by bubbling the carrier gas into the lithium-containing precursor. The carrier gas and lithium-containing precursor are then introduced into the reaction chamber as a vapor. If necessary, the container may be heated to a temperature that permits the lithium-containing precursor to be in its liquid phase and to have a sufficient vapor pressure. The carrier gas may include, but is not limited to, Ar, He, N₂,and mixtures thereof. The container may be maintained at temperatures in the range of, for example, approximately 0° C. to approximately 150° C. Those skilled in the art recognize that the temperature of the container may be adjusted in a known manner to control the amount of lithium-containing precursor vaporized.

In addition to the optional mixing of the lithium-containing precursor with solvents prior to introduction into the reaction chamber, the lithium-containing precursor may be mixed with reactant species inside the reaction chamber. Exemplary reactant species include, without limitation, metal precursors such as strontium-containing precursors, barium-containing cursors, aluminum-containing precursors such as TMA, and any combination thereof.

When the desired lithium-containing film also contains oxygen, such as, for example and without limitation, LiₓNiO₂ or LiₓCoO₂, the reactant species may include an oxygen source which is selected from, but not limited to, O₂, O₃, H₂O, NO, H₂O₂, carboxylic acids (C₁-C₁₀, linear and branched), acetic acid, formalin, formic acid, alcohols, para-formaldehyde, and combinations thereof.

When the desired lithium-containing film also contains another metal, such as, for example and without limitation, Ni, Co, Fe, V, Mn, P, Ti, Ta, Hf, Zr, Nb, Mg, Al, Sr, Y, Ba, Ca, As, Sb, Bi, Sn, Pb, or combinations thereof, the reactant species may include a metal source which is selected from, but not limited to, metal alkyls such as SbR^{i′}₃ or SnRphu i′₄ (wherein each R^{i′}is independently H or a linear, branched, or cyclic C1-C6 carbon chain), metal alkoxides such as Sb(ORⁱ)₃ or Sn(ORⁱ)₄ (where each Rⁱ is independently H or a linear, branched, or cyclic C1-C6 carbon chain), and metal amines such as Sb(NR¹R²)(NR³R⁴)(NR⁵R⁶) or Ge(NR¹R²)(NR³R⁴)(NR⁵R⁶)(NR⁷R⁸) (where each R¹, R², R³, R⁴, R⁵, R⁶, R⁷, and R⁸ is independently H, a C1-C6 carbon chain, or a trialkylsilyl group, the carbon chain and trialkylsilyl group each being linear, branched, or cyclic), and any combination thereof.

The lithium-containing precursor and one or more reactant species may be introduced into the reaction chamber simultaneously (chemical vapor deposition), sequentially (atomic layer deposition), or in other combinations. For example, the lithium-containing precursor may be introduced in one pulse and two additional metal sources may be introduced together in a separate pulse [modified atomic layer deposition]. Alternatively, the reaction chamber may already contain the reactant species prior to introduction of the lithium-containing precursor. The reactant species may be passed through a plasma system localized remotely from the reaction chamber, and decomposed to radicals. Alternatively, the lithium-containing precursor may be introduced to the reaction chamber continuously while other metal sources are introduced by pulse (pulsed-chemical vapor deposition). In each example, a pulse may be followed by a purge or evacuation step to remove excess amounts of the component introduced. In each example, the pulse may last for a time period ranging from about 0.01 s to about 10 s, alternatively from about 0.3 s to about 3 s, alternatively from about 0.5 s to about 2 s.

In one non-limiting exemplary atomic layer deposition type process, the vapor phase of a lithium-containing precursor is introduced into the reaction chamber, where it is contacted with a suitable substrate. Excess lithium-containing precursor may then be removed from the reaction chamber by purging and/or evacuating the reactor. An oxygen source is introduced into the reaction chamber where it reacts with the absorbed lithium-containing precursor in a self-limiting manner. Any excess oxygen source is removed from the reaction chamber by purging and/or evacuating the reaction chamber. If the desired film is a lithium oxide film, this two-step process may provide the desired film thickness or may be repeated until a film having the necessary thickness has been obtained.

Alternatively, if the desired film is a lithium metal oxide film, the two-step process above may be followed by introduction of the vapor of a metal precursor into the reaction chamber. The metal precursor will be selected based on the nature of the lithium metal oxide film being deposited. After introduction into the reaction chamber, the metal precursor is contacted with the substrate. Any excess metal precursor is removed from the reaction chamber by purging and/or evacuating the reaction chamber. Once again, an oxygen source may be introduced into the reaction chamber to react with the second metal precursor. Excess oxygen source is removed from the reaction chamber by purging and/or evacuating the reaction chamber. If a desired film thickness has been achieved, the process may be terminated. However, if a thicker film is desired, the entire four-step process may be repeated. By alternating the provision of the lithium-containing precursor, metal precursor, and oxygen source, a film of desired composition and thickness can be deposited.

The lithium-containing films or lithium-containing layers resulting from the processes discussed above may have the general formula LiₓM_{y}O_{z}, wherein M=Ni, Co, Fe, V, Mn, or P and x, y, and z range from 1 to 8 inclusive. Preferably, the lithium-containing films are selected from LiₓNiO₂, LiₓCO₂, LiₓV₃O₈, LiₓV₂O₅, and LiₓMn₂O₄, wherein x ranges from 1 to 8 inclusive. One of ordinary skill in the art will recognize that by judicial selection of the appropriate lithium-containing precursor and reactant species, the desired film composition may be obtained.

The deposited film composition will be dependent upon the application. For example, the following lithium-containing films may be used for fuel cell and battery applications.
Li(1+x)V₃O₈, LiₓV₂O₅,
LiₓMn₂O₄
LiₓNiO₂, LiₓCoO₂.

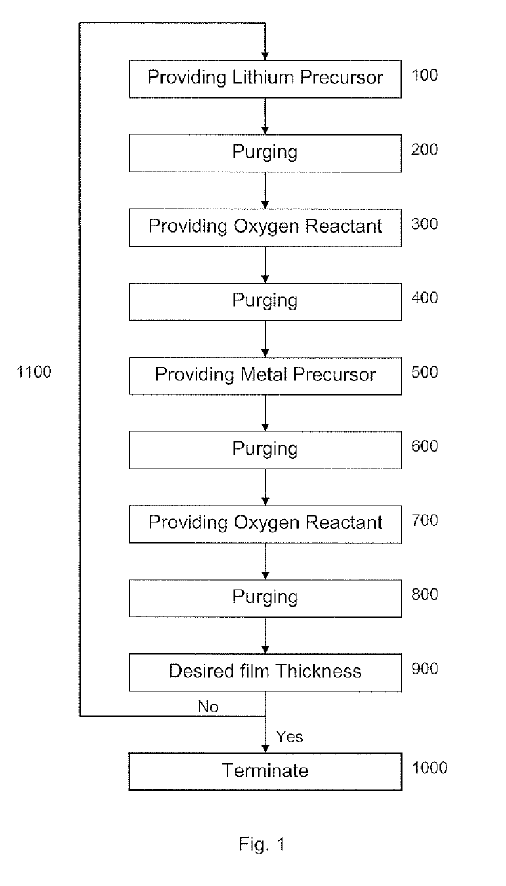

As shown in FIG. 1, in an exemplary atomic layer deposition process, the vapor phase of a first reactant, the lithium-containing precursor, is introduced into the reactor 100, where it is contacted with a suitable substrate. Excess lithium-containing precursor is removed from the reactor by purging and/or evacuating the reactor 200. A source of oxygen is introduced into the reactor 300 where it reacts with the absorbed lithium-containing containing precursor in a self-limiting manner. The excess oxygen is removed from the reactor by purging and/or evacuating the reactor 400.

Subsequently, the vapor of a second metal-containing precursor, which is different from the lithium-containing precursor, is introduced into the reactor 500 and excess precursor is removed from the reactor by purging and/or evacuating the reactor 600. The second metal-containing precursor will be selected based on the nature of the lithium metal-containing film being deposited. A source of oxygen is introduced into the reactor 700 to react with the second metal precursor. Excess oxygen is removed from the reactor by purging and/or evacuating the reactor 800.

If the desired film thickness has been achieved, the process may be terminated 1000. However, if a thicker film is desired or additional thickness is desired, the cycle may be repeated 1100. By alternating the provision of the lithium-containing precursor, the second metal-containing precursor, and the source of oxygen, a metal-containing thin film of desired composition and thickness can be deposited.

### EXAMPLES

The following non-limiting examples are provided to further illustrate embodiments of the invention. However, the examples are not intended to be all inclusive and are not intended to limit the scope of the inventions described herein. The following examples illustrate possible synthesis methods. All reactions were carried out under inert atmosphere of purified nitrogen.

### Example 1

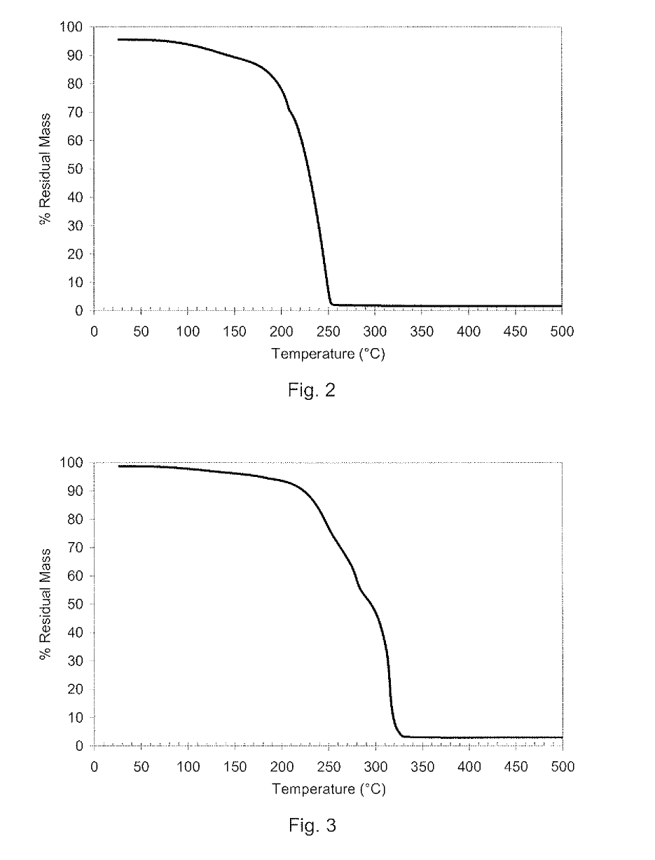

Li(N^{iPr}-amd): Diisopropylcarbodiimide (2.44 g, 19.34 mmol) and THE were added to a flask and cooled to −78° C. A solution of methyllithium (12.1 mL, 19.34 mmol) was added dropwise while vigorously stirring. The reaction mixture was allowed to warm to room temperature and further stirred for 1 h. Solvents were removed under vacuum at 40° C. A white solid was obtained in quantitative yield. The white solid was sublimed at 190° C. at 10 mTorr. Yield 274 g (95%). FIG. 2 a graph of thermogravimetric analysis (TGA) data demonstrating percent of weight loss vs. temperature of the white solid, Li(N^{iPr}-amd).

### Example 2

Li(N^{tBu}-amd): Diisopropylcarbodiimide (2.40 g, 15.56 mmol) and THE were added to a flask and cooled to −78 ° C. A solution of methyllithium (9.8 mL, 15.56 mmol) was added dropwise while vigorously stirring. The reaction mixture was allowed to warm to room temperature and further stirred for 1 h. Solvents were removed under vacuum at 40° C. A white solid was obtained in quantitative yield. The white solid was sublimed at 190° C. at 10 mTorr. Yield 2.2 g (80%). FIG. 3 is a graph of TGA data demonstrating percent of weight loss vs. temperature of Li(N^{tBu}-amd).

### Example 3

Li(N^{iPr}-fmd): Diisopropylformidine (1.00 g, 7.8 mmol) and THE were added to a flask and cooled to −78° C. A solution of methyllithium (4.9 mL, 7.8 mmol) was added dropwise while vigorously stirring. The reaction mixture was allowed to warm to room temperature and further stirred for 1 h. Solvents were removed under vacuum at 40° C. A white solid was obtained in quantitative yield. TGA analysis was not performed.

### Example 4

Li(Me₅Cp): Pentamethylcyclopentadiene (3.00 g, 22.1 mmol) and THF (50 mL) were added to a flask and cooled to −78 C. A solution of methyllithium (13.8 mL, 22.1 mmol) was added dropwise while vigorously stirring. The reaction mixture was allowed to warm to room temperature and further stirred for 1 h. Solvents were removed under vacuum at 40 C. A white solid was obtained in quantitative yield. TGA analysis was not performed.

### Example 5

Li(Me₄EtCp): Ethyltetramethylcyclopentadiene (3.00 g, 19.96 mmol) and THF (50 mL) were added to a flask and cooled to −78 ° C. A solution of methyllithium (12.5 mL, 19.96 mmol) was added dropwise while vigorously stirring. The reaction mixture was allowed to warm to room temperature and further stirred for 1 h. Solvents were removed under vacuum at 40° C. A white solid was obtained in quantitative yield. The white solid was sublimed at 190° C. at 30 mTorr. High residue resulted upon TGA analysis.

### Example 6

Li(tBu₃Cp): Tri-tert-butylcyclopentadiene (3.00 g, 12.80 mmol) and THF (50 mL) were added to a flask and cooled to −78° C. A solution of methyllithium (8.0 mL, 12.80 mmol) was added dropwise while vigorously stirring. The reaction mixture was allowed to warm to room temperature and further stirred for 1 h. Solvents were removed under vacuum at 40° C.

A white solid was obtained in quantitative yield. TGA analysis indicated a melting point of 110° C. with less than 2% residual mass. ¹H NMR (THF-d₈), δ: 1.19 (9H, C(CH₃)₃), 1.37 (18H, C(CH₃)₃), 5.62 (2H, Cp-H).

### Example 7

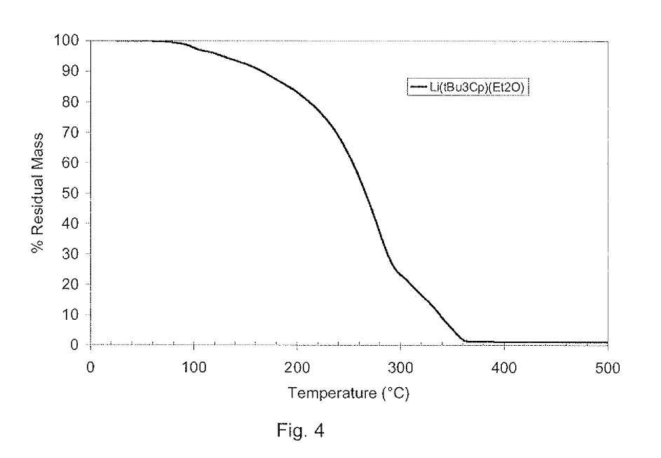

Li(tBu₃Cp)·Et₂O: Tri-tert-butylcyclopentadiene (4.50 g, 19.19 mmol) and diethyl ether (50 mL) were added to a flask and cooled to −78° C. A solution of butyllithium (7.68 mL of 2.5M, 19.19 mmol) was added dropwise while vigorously stirring. The reaction mixture was allowed to warm to room temperature and further stirred for 1 h. Solvents were removed under vacuum at 40° C. A white solid was obtained in quantitative yield. FIG. 4 is a graph of TGA data demonstrating percent of weight loss vs. temperature of Li(tBu₃Cp)·Et₂O. ¹H NMR (THF-d₈), d: 1.12 (6H, (CH₃CH₂)₂0), 1.19 (9H, C(CH₃)₃), 1.37 (18H, C(CH₃)₃), 3.38 (4H, (CH₃CH₂)₂0), 5.62 (2H, Cp-H).

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1-13. (canceled)

14. A method of forming a lithium-containing film by vapor deposition, the method comprising
providing a reaction chamber having at least one substrate disposed therein;
introducing into the reaction chamber a vapor including a lithium-containing precursor;
contacting the vapor with the substrate to form a lithium-containing layer on at least one surface of the substrate using a vapor deposition process,
wherein the lithium-containing precursor is selected from the group consisting of:
a) Li(Me₅Cp).THF, Li(Me₄Cp).THF, Li(Me₄EtCp).THF, Li(iPr₃Cp).THF, Li(tBu₃Cp).THF, Li(tBu₂Cp).THF, Li(Me₅Cp), Li(Me₄Cp), Li(Me₄EtCp), Li(iPr₃Cp), Li(tBu₃Cp), Li(tBu₂Cp), Li(Me₃SiCp).THF, Li(Et₃SiCp).THF, Li(Me₃SiCp), and Li(Et₃SiCp); 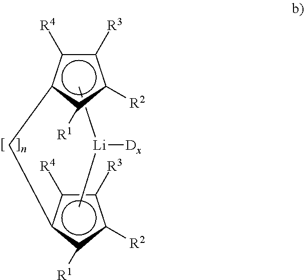
wherein:
each R¹, R², R³, and R⁴ is independently selected from:
i. hydrogen;
ii. linear or branched C₁-C₁₅ alkyl, alkenyl, alkynyl, or alkylsilyl groups, which are independently substituted or unsubstituted; or
iii. cyclic or bicyclic ring systems, which are independently substituted or unsubstituted;
n=0-4;
each D is independently selected from a monodentate, bidentate, tridentate, or polydentate neutral coordinating ligand system; and
x≧0; 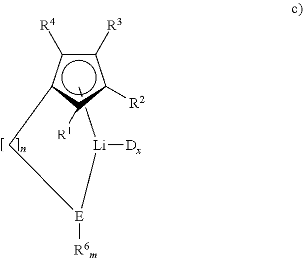
wherein:
each R¹, R², R³, R⁴ and R⁶ is independently selected from:
i. hydrogen;
ii. linear or branched C₁-C₁₅ alkyl, alkenyl, alkynyl, or alkylsilyl groups, which are independently substituted or unsubstituted; or
iii. cyclic or bicyclic ring systems, which are independently substituted or unsubstituted;
E=N, O, S, P;
each D is independently selected from a monodentate, bidentate, tridentate, or polydentate neutral coordinating ligand system; and
n=0-4, m≧0 and x≧0; 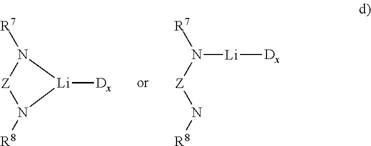
wherein:
each R⁷ and R⁸ is independently selected from:
i. hydrogen; or
ii. linear or branched C₁-C₁₅ alkyl, alkenyl, alkynyl, or alkylsilyl groups, which are independently substituted or unsubstituted;
Z is any linear or branched C₁-C₁₅ alkyl, alkenyl, or alkynyl groups, which are independently substituted or unsubstituted and Z bridges two nitrogen centers at any point of the alkyl, alkenyl, or alkynyl groups;
D is independently selected from a monodentate, bidentate, tridentate, or polydentate neutral coordinating ligand system; and
x≧0; and 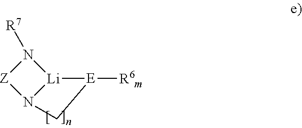
wherein:
each R⁶ and R⁷ is independently selected from:
i. hydrogen;
ii. linear or branched C₁-C₁₅ alkyl, alkenyl, alkynyl, or alkylsilyl groups, which are independently substituted or unsubstituted;
E=N, O, S, P; and
n=0-4 and m≧0.

15. The method of claim 14, wherein each D is independently selected from the group consisting of THF, DME, and tmeda.

16. The method of claim 14, wherein the lithium-containing precursors is selected from group consisting of Li(N^{Me}-amd).THF, Li(N^{Me}-fmd).THF, (N^{Et}-amd).THF, Li(N^{Et}-fmd).THF, Li(N^{iPr}-amd).THF, Li(N^{iPr}-fmd).THF, Li(N^{tBu}-amd).THF, Li(N^{tBu}-fmd).THF, Li(N^{Me}-amd), Li(N^{Me-fmd), (N}^{Et}-amd), Li(N^{Et}-fmd), Li(N^{iPr}-amd), Li(N^{iPr}-fmd), Li(N^{tBu}-amd), and Li(N^{tBu}-fmd).

17. The method of claim 14, further comprising introducing into the reaction chamber a first reactant species.

18. The method of claim 17, further comprising introducing into the reaction chamber a second metal-containing precursor and a second reactant species; and
depositing a film comprising a lithium metal oxide on the substrate.

19. The method of claim 18, wherein the second metal-containing precursor contains a metal selected from the group consisting of nickel, cobalt, iron, vanadium, manganese and phosphorus.

20. The method of claim 18, wherein the first and second reactant species are independently selected form the group consisting of O₃, O₂, H₂O, H₂O₂, carboxylic acids (C₁-C₁₀, linear and branched), formaline, formic acid, alcohols, and mixtures thereof.

21. The method of claim 19, wherein the lithium metal oxide has the following formula: LiₓM_{y}O_{z}, wherein M═Ni, Co, Fe, V, Mn, or P and x, y, and z range from 1 to 8 inclusive.

22. The method of claim 21, wherein the lithium metal oxide is selected from the group consisting of Li₂NiO₂, Li₂CoO₂, Li₂V₃O₅, LiₓV₂O₈, and Li₂Mn₂O₄.

23. The method of claim 14, wherein the vapor deposition process is atomic layer deposition.
